(19) United States
(12) Patent Application Publication
(10) Pub. No.: US 2008/0046930 A1
(43) Pub. Date: Feb. 21, 2008

(54) Apparatus, Methods and Computer Program Products for Audience-Adaptive Control of Content Presentation

(75) Inventors: William L. Smith, Marietta, GA (US); Robert A. Koch, Norcross, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/465,235

(22) Filed: Aug. 17, 2006

(51) Int. Cl. H04N 5/445; H04N 7/10; H04N 7/025; G06F 13/00; G06F 3/00

(52) U.S. Cl. 725/46; 725/34; 725/35

(57) ABSTRACT

Embodiments of the present invention provide apparatus, methods and/or computer program products for controlling presentation of content. In some method embodiments, a profile is stored for each of a plurality of potential audience members. Presence of a group of audience members of the plurality of potential audience members is detected. Responsive to the detection, a content presentation device is controlled based on collective consideration of the stored profiles of the group of audience members.

### FIELD OF THE INVENTION

This invention relates to content presentation apparatus, methods, and computer program products and, more particularly, to apparatus, methods and computer program products for controlling content presentation.

### BACKGROUND OF THE INVENTION

The evolution of cable, satellite, cellular wireless and other broadband communications technologies, along with the concurrent development of content presentation devices, such as digital TVs, satellite radios, audio players, digital video disc (DVD) players and other record/playback devices, has led to an explosion in the volume and variety of content available to consumers. For example, digital cable and satellite television services now typically offer hundreds of different channels from which to choose, including general interest channels that offer a variety of different types of content along lines similar to traditional broadcast stations, as well as specialized channels that provide more narrowly focused entertainment, such as channels directed to particular interests, such as particular sports, classic movies, shopping, children's programming, and the like.

As the sources and types of content proliferate, the task of finding and selecting desirable or appropriate content for an audience may become problematic. In particular, choosing appropriate content for a group typically involves an ad hoc manual selection of programming, which may be supplemented by programming guides and other aids. The task of programming selection may be complicated due to the sheer volume of available content, the variety of different rating systems employed for different types of content, and by the increasingly ready availability of unregulated programming, such as programming with strong sexual content, violence and/or strong language, which may be inappropriate for some users.

### SUMMARY OF THE INVENTION

Embodiments of the present invention provide apparatus, methods and/or computer program products for controlling presentation of content. In some method embodiments, a profile is stored for each of a plurality of potential audience members. Presence of a group of audience members of the plurality of potential audience members is detected. Responsive to the detection, a content presentation device is controlled based on collective consideration of the stored profiles of the group of audience members.

Detection of the presence of a group of audience members of the plurality of potential audience members may include detecting addition of a new audience member to a group of existing audience members. Control of the content presentation device may include altering content presentation by the content presentation device responsive to the detection of the new audience member. Altering content presentation by the content presentation device responsive to the detection of the new audience member may include controlling the content presentation device based on a collective consideration of stored profiles of the new audience member and the group of existing audience members.

In some embodiments, the stored profiles each comprise a plurality of parameters, and controlling a content presentation device based on collective consideration of the stored profiles of the group of audience members may include applying different rules for respective ones of the profile parameters. In further embodiments, controlling a content presentation device based on collective consideration of the stored profiles of the group of audience members may include generating a collective profile for the group of audience members from the stored profiles responsive to the detection of the group of audience members and controlling the content presentation device responsive to the collective profile. According to some embodiments, controlling a content presentation device based on collective consideration of the stored profiles of the croup of audience members may include suspending a presentation of content based on collective consideration of the stored profiles of the group of audience members, terminating a presentation of content based on collective consideration of the stored profiles of the group of audience members, controlling access to a content channel based on collective consideration of the stored profiles of the group of audience members, editing content based on collective consideration of the stored profiles of the group of audience members and/or providing supplemental content based on collective consideration of the stored profiles of the group of audience members.

In still further embodiments, controlling a content presentation device based on collective consideration of the stored profiles of the group of audience members may include generating a content monitoring message based on collective consideration of the stored profiles of the group of audience members. Generating a content monitoring message based on collective consideration of the stored profiles of the group of audience members may include generating an alarm and/or a message based on collective consideration of the stored profiles of the group of audience members.

According to additional embodiments of the present invention, controlling a content presentation device based on collective consideration of the stored profiles of the group of audience members comprises providing a content guide based on collective consideration of the stored profiles of the group of audience members. Information in the content guide may be arranged (e.g., prioritized) based on relative preferences of the group of audience members indicated in the stored profiles.

Further embodiments of the present invention provide a content presentation system including a content presentation device configured to provide an audio and/or visual output and an audience-adaptive controller configured to store a profile for each of a plurality of potential audience members, to detect presence of a group of audience members of the plurality of potential audience members and to control the content presentation device based on collective consideration of the stored profiles of the group of audience members.

Additional embodiments of the present invention provide a computer program product for controlling a content presentation device. The computer program product includes computer program code embodied in a storage medium, the computer program code including program code configured to store a profile for each of a plurality of potential audience members, to detect presence of a group of audience members of the plurality of potential audience member and to control the content presentation device based on collective consideration of the stored profiles of the group of audience members.

### BRIEF DESCRIPTION OF THE DRAWINGS

FIG. 1 illustrates a content presentation apparatus, methods and/or computer program products according to some embodiments of the present invention.

FIGS. 2, 6-8, 10 and 14 are flowcharts illustrating operations for controlling content presentation according to some embodiments of the present invention.

FIGS. 3-5, 12 and 13 and are flow diagrams illustrating operations for generating audience profiles according to some embodiments of the present invention.

FIG. 9 illustrates a content presentation device providing display of a content presentation monitoring message according to some embodiments of the present invention.

FIG. 9 illustrates a remote device providing display of a content presentation monitoring message according to further embodiments of the present invention

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element, it can be directly responsive to the other element, or intervening elements may be present. In contrast, when an element is referred to as being “directly responsive” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Some embodiments of the present invention may arise from recognition that it may be desirable to automatically or semi-automatically control content presentation based on collective consideration of preferences, limitation, restrictions and/or other parameters associated with the individual members of the audience. In particular, it may be cumbersome to manually select and or alter content, such as cable, satellite or broadband video programming, to conform to a changing audience makeup. In embodiments of the present invention, responsive to detection of a group of audience members, an audience-adaptive controller automatically controls a content presentation device, based on collective consideration of audience member profiles stored in a database of individual potential audience member profiles. As used herein, a “content presentation device” may comprise any device operative to provide audio and/or visual content to an audience, including, but not limited to, televisions, audio systems (stereo systems, satellite radios, etc.), playback devices (DVD, tape, DVR, TiVo®, etc.), internet and wireless video devices, set-top boxes, and the like.

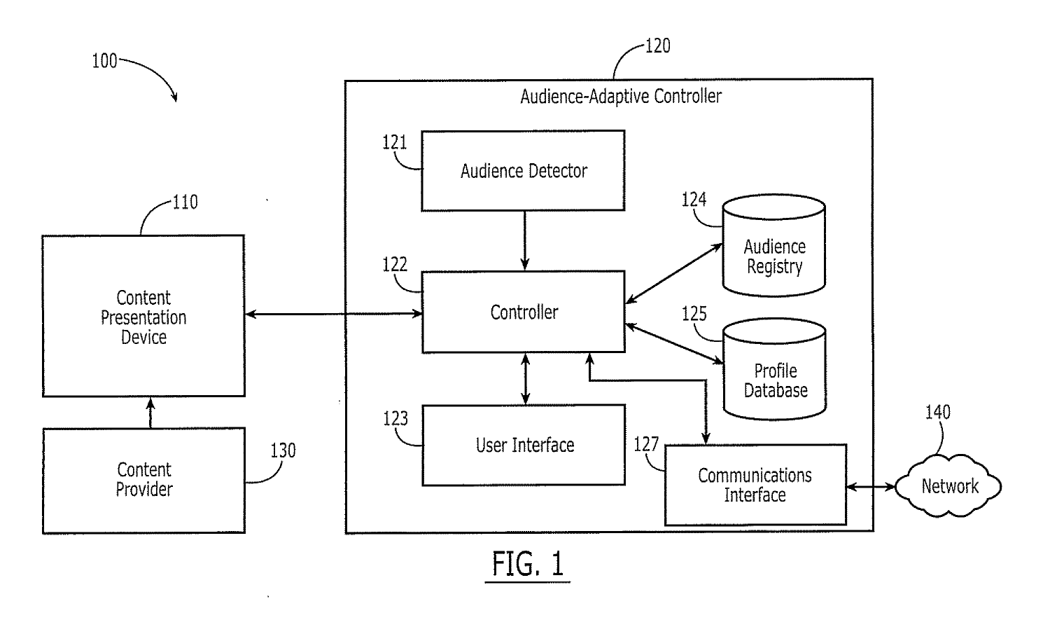

FIG. 1 illustrates a content presentation system 100 and operations thereof according to some embodiments of the present invention. A content presentation device 110, such as a television, home theater system, set-top box, video/audio playback device, or the like, is controlled by an audience-adaptive controller 120. The content presentation device 110 may, for example, be a device configured to receive content from a content provider 130, such as a subscription service, pay-per-view service, broadcast station or other content source and/or may be configured to present locally-stored content. In the illustrated embodiments, the audience-adaptive controller 120 is configured to store individual profiles for potential audience members in profile database 125. The audience-adaptive controller 120 further includes an audience detector 121 that is configured to detect the presence of audience members and to store information pertaining thereto, such as identifying information, in an audience registry 124.

A presentation device controller 122 is configured to control the presentation device 110 responsive to the audience registry 124 based on consideration of stored profiles in the database 125 corresponding to the detected audience members. As also illustrated, the presentation device controller 122 may be further configured to interact with user interface circuitry 123, for example, input and/or output devices that may be used to generate alarms and/or convey content presentation monitoring messages and/or to accept control inputs from a user, such as user inputs that enable and/or override control actions by the presentation device controller 122. The presentation device controller 122 may also be configured to interoperate with a communications interface 127, for example, a network interface that may be used to communicate messages, such as text and/or control messages to and/or from a remote user (e.g. a parent), over an external network 140.

It will be understood that the content presentation system 100 may be implemented in a number of different ways. For example, the content presentation device 110 may include any of a number of different types of devices that are configured to present audio and/or visual content to an audience. The audience-adaptive controller 120 may be integrated with the content presentation device 110 and/or may be a separate device configured to communicate with the content presentation device 110 via a communications media using, for example, wireline, optical or wireless signaling.

In general, the audience-adaptive controller 120 may be implemented using analog and/or digital hardware and/or combinations of hardware and software. The presentation device controller 122 may, for example, be implemented using a microprocessor, microcontroller, digital signal processor (DSP) or other computing device that is configured to execute program code such that the computing device is configured to interoperate with the content presentation device 110, the audience detector 121 and the user interface 123. The audience registry 124 and the profile database 125 may, for example, be magnetic, optical, solid state or other storage medium configured to store data under control of such a computing device. The audience detector 121 may utilize any of a number of different techniques to detect the presence of audience members, including, but not limited to, login/authorization techniques using communications devices (e.g., cellphones, PDA's and the like), electronic ID techniques (e.g., magnetic card, RFID, etc.), biometric detection techniques (e.g. voice, retina, facial recognition, etc.), motion detection techniques, and/or proximity detection techniques.

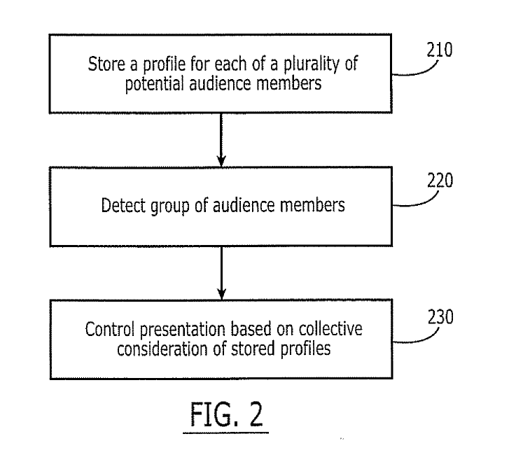

FIG. 2 illustrates operations that may be performed by the content presentation system 100 of FIG. 1 according to some embodiments of the present invention. A profile is stored for each of a plurality of potential audience members (block 210). As explained in greater detail below, the profiles may be profiles of actual persons and/or generic (paradigmatic) profiles that correspond to particular types of audience members. The content presentation system 100 detects the presence of a group of audience members (block 220). Responsive to detection of the group of audience members, the content presentation device 110 is controlled based on collective consideration of stored profiles corresponding to the respective detected audience members (block 230).

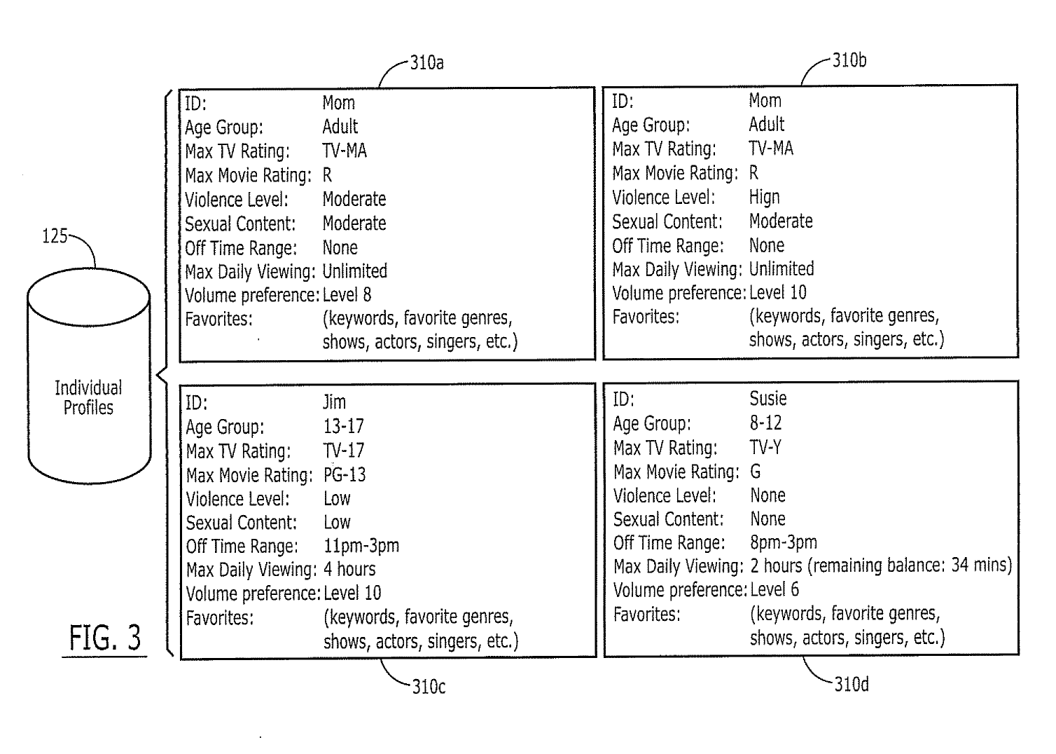

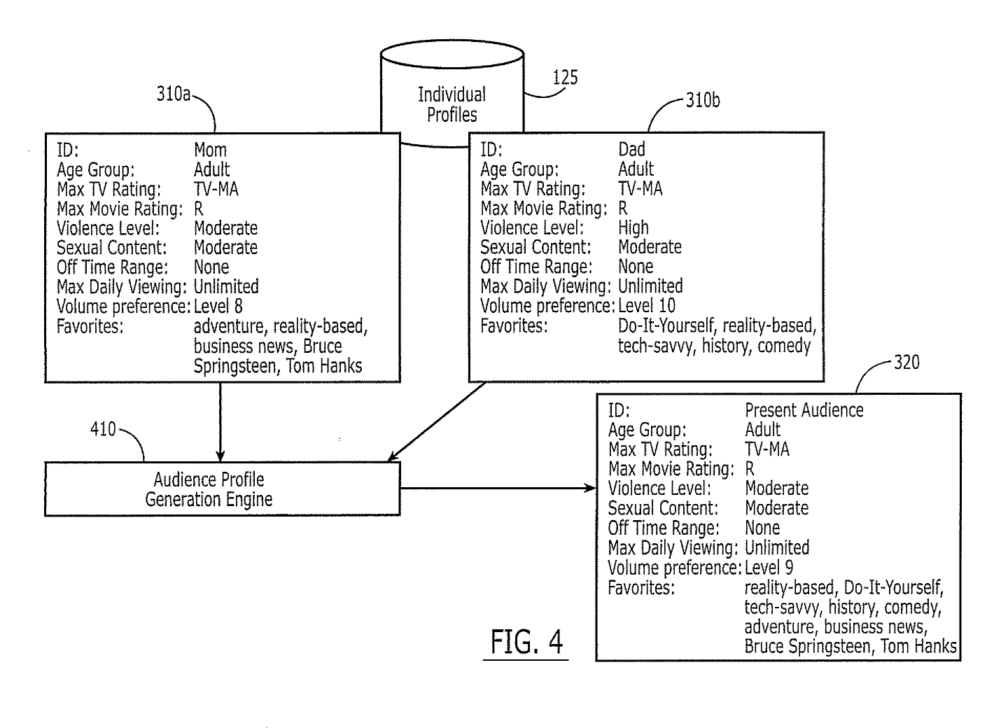

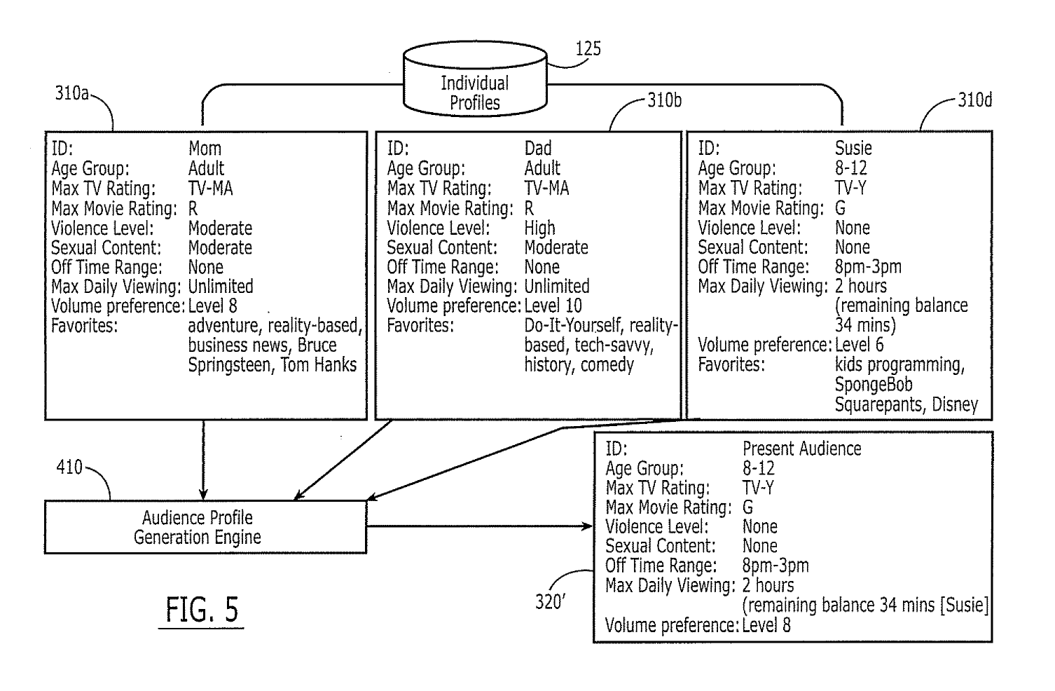

FIG. 3 illustrates examples of audience member profiles according to some embodiments of the present invention, and FIGS. 4 and 5 illustrate exemplary operations that may be used with such profiles to control content presentation. Referring to FIG. 3, profiles stored in a potential audience member database 125 may include a profile 310a for “Mom,” a profile 310b for “Dad,” a profile 310c for “Jim,” and a profile 310d for “Susie.” Each of the profiles 310a, 310b, 310c, 310d may include a plurality of parameters, such as any of a number of different types of preferences and/or constraints associated with presentation of content to the audience member. In the illustrated embodiments, parameters included in the profiles 310a, 310b, 310c, 310d include an age group parameter, a maximum acceptable TV rating parameter, a maximum acceptable movie (MPAA) rating parameter, a maximum acceptable violence level parameter, a maximum acceptable sexual content parameter, a time of view restriction parameter, a maximum daily viewing time parameter, an audio volume preference parameter, and one or more “favorites” parameters. While the profiles 310a, 310b, 310c, 310d illustrated in FIG. 3 correspond to actual persons, in some embodiments, generic (paradigmatic) profiles, such as a “guest” profile, a “child” profile, or the like, may be used and applied to provide parametric inputs for non-specifically identified detected audience members.

Individual profiles, such as the profiles 310a, 310b, 310c, 310d illustrated in FIG. 3, may be generated and/or modified in any of a number of different ways in various embodiments of the present invention. For example, profiles may be manually entered and/or edited by the actual individual, for example, by interaction with an interactive user interface, and/or may be created and/or maintained by an administrator with special access privileges. Individual profiles may also be automatically generated. For example, an individual profile may be adaptively generated by logging an audience member's behavior over time and determining viewing habits, programming choices and the like.

According to some embodiments of the present invention, rules, algorithms or other processes may be used to generate parameters for a “collective” audience profile from parameters of stored individual audience member profiles, such as the profiles 310a, 310b, 310c, 310d illustrated in FIG. 3. For example, referring to FIG. 4, responsive to detection of a group of audience members including “Mom” and “Dad,” an audience profile generation engine 410, for example, a computer program object, application, module or the like implemented in the presentation device controller 122 of FIG. 2, may generate a collective profile 320 using information from the individual profiles 310a, 310b for “Mom”¹ and “Dad” stored in the profile database 125. For example, parameters in the collective profile 320 may be generated by arbitration, computation or other operations on the parameters in the individual profiles 310a, 310b.

Generally, respective different rules, algorithms or other processes may be used for respective parameters. For example, as shown in FIG. 4, age group, TV rating, movie rating, sexual content and violence level parameters in the collective profile 320 may be determined by applying a “least common denominator” rule to the same parameters in the individual profiles 310a, 310b. In contrast, an averaging rule may be applied for the volume preference parameter and a “union of sets” rule is applied for favorites. It will be appreciated that other operations may be used, and that the type of operation applied in generating a particular parameter for a collective profile may further dependent upon other factors. For example, one rule may be applied for a first type of audience (e.g., one consisting only of children), while another rule may be applied for a second audience (e.g., one consisting only of adults). Rules/algorithms may also be adapted based on other factors, such as time of day and/or location.

The collective profile 320 so generated may be used to control presentation of content to the detected audience consisting of “Mom” and “Dad”, for example, to control the content presentation device 110 of FIG. 1. For example, the presentation device controller 122 may choose a content channel and/or provide a content guide (e.g., a customized channel guide) that meets the TV rating, movie rating, violence level, sexual content and favorites parameters of the collective profile 320, and may present the chosen content using the volume level included in the collective profile 320.

According to further aspects of the present invention, an adaptive content presentation system, such as the system 100 of FIG. 1, may alter content presentation responsive to detection of a new audience member. For example, building on the example of FIG. 4, FIG. 5 illustrates generation of a new collective profile 320′ upon detection of a new audience member “Susie.” The age group, TV rating, movie rating, violence level and sexual content parameters of the new collective profile 320′ are modified according to a “lowest common denominator” rule, such that content and/or content choices are limited to material appropriate to Susie. Viewing time and duration parameters are also modified in line with the “least common denominator” restrictions in Susie's profile 310d, while volume level is derived by averaging.

The new collective profile 320′ may then be used to control programming, programming choices and/or presentation characteristics (e.g., volume). For example, the presentation device controller 122 may provide content meeting the requirements of the new collective profile 320′ and/or may provide content choices that are consistent with the parameters in the new profile 320′. In some embodiments, for example, the presentation device controller 122 may switch between an “uncut” or “unrated” version of a movie to a more sanitized version of the movie that may be more appropriate for Susie. The sanitized version may meet the collective profile 320′ and/or may represent a “best available fit” to the new profile 320′. Presentation of the new content may, for example, be made subject to an enable and/or override input provided by “Mom” or “Dad” via, for example, the user interface 123 and/or the communications interface 127 shown in FIG. 1. Upon detection of Susie departing, i.e., detection of Susie's absence, a new collective profile, for example, the profile 320 shown in FIG. 4 or some other collective profile that includes information reflecting other audience members who may have been detected in the interim, may be adopted.

In general, adaptation of content presentation responsive to audience dynamics may include any of a number of actions. For example, in addition to changing to “safe” content as described above, an audience-adaptive content presentation system according to some embodiments of the present invention may, for example, turn off a content presentation device, pause a content presentation, mute or change volume of a content presentation device, change electronic content guides (e.g., change parental control filters and/or prioritization of display of programming choices in a channel guide), change advertising content or targeting in a content presentation, provide supplemental content (e.g., close captioning) and/or provide alarms or messages in a content presentation.

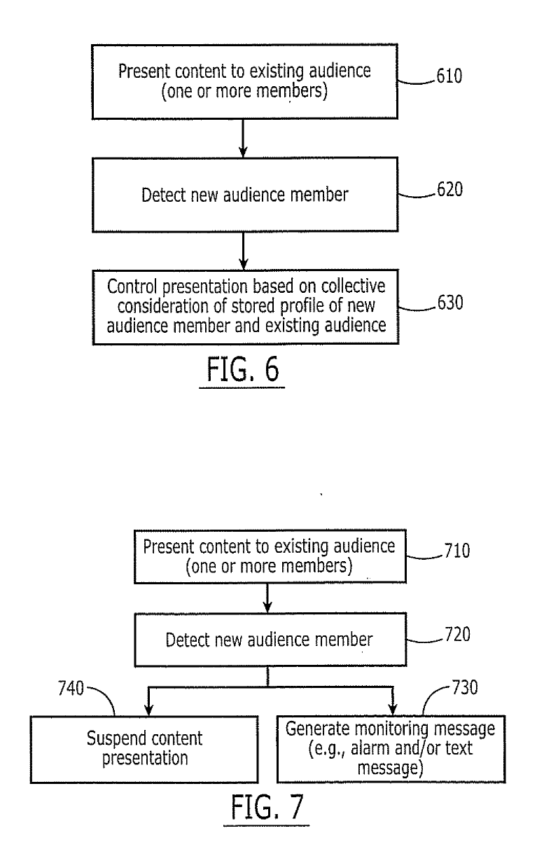

Operations for controlling content presentation according to such embodiments of the present invention are shown in FIG. 6. Content is presented to an audience of one more members (block 610). Responsive to detection of a new audience member (block 620), a content presentation device is controlled based on collective consideration of a stored audience member profile corresponding to the new audience member and the audience profile(s) of the previously existing audience (block 630).

In further embodiments of the present invention illustrated in FIG. 7, additional content presentation-related control actions may be performed based on collective consideration of individual audience member profiles. Content is presented to an audience of one more members (block 710). Responsive to detection of a new audience member (block 720), content presentation may be suspended (block 740). For example, referring to FIG. 5, upon detection of Susie's presence, the presentation device controller 122 may halt presentation of content having inappropriate violent or sexual content, and may switch to more age-appropriate conduct and/or provide Mom or Dad with the ability to make new programming choices, override the suspension of content and/or momentarily pause presentation of content to allow time for Mom and Dad to send Susie back to bed. In addition to pausing content presentation, the presentation device controller 122 may also generate a content presentation monitoring message, for example, a message presented on the content presentation device 110 itself and/or a message, for example, an alarm, cellular text message or email transmission, delivered, for example, via the user interface 123 and/or communications interface 127 shown in FIG. 1.

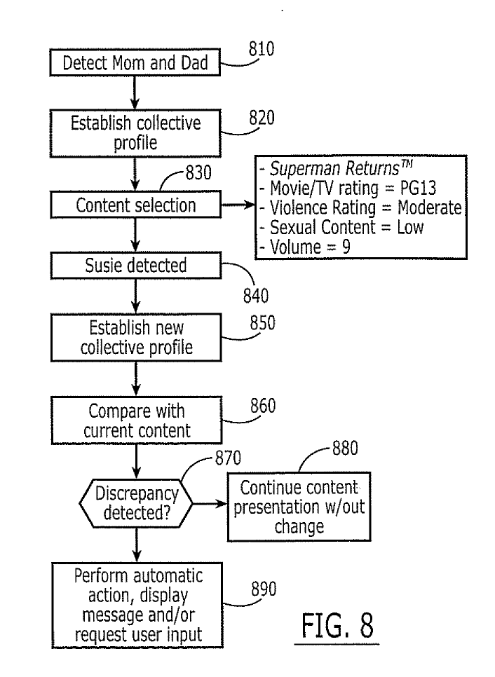

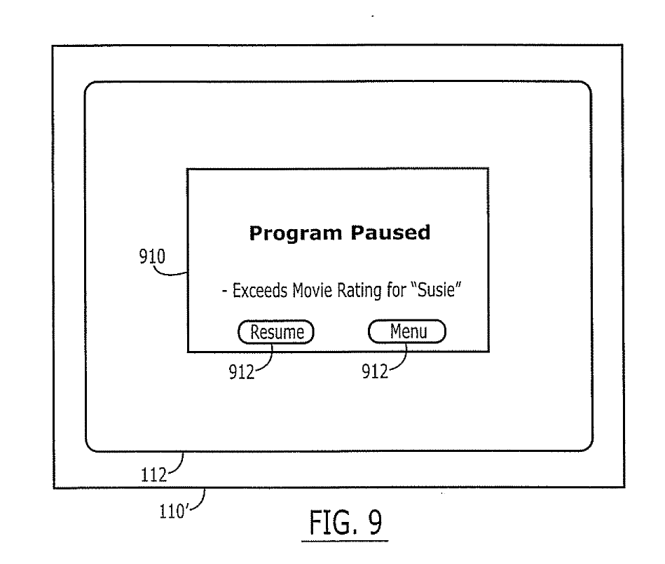

FIGS. 8 and 9 illustrate exemplary operations according to some embodiments of the present invention, in the context of the examples described with reference to FIGS. 4 and 5 above. Referring to FIG. 8, a first audience including “Mom” and “Dad” is detected (block 810) and, in response, a first collective profile (e.g., the profile 320 of FIG. 4) is established (block 820). In accordance with the collective profile, content is selected and presented (block 830), here a movie, Superman Returns™, having a movie rating of PG-13, a moderate violence rating and a low sexual content rating is presented at an audio volume level of 9. For example, the movie may be presented automatically and/or in response to user selection from a content guide provided in response to the collective profile.

At a subsequent time, “Susie” is detected (block 840) and, in response to the detection, a new collective profile (e.g., the profile 320′ of FIG. 5) is established (block 850). Parameters of the new collective profile are compared with those of the content currently being presented (block 860). If a discrepancy between a collective profile parameter and the current content is not detected, the content presentation may proceed unaltered (blocks 870, 880). However, if a discrepancy is detected, the content presentation may be altered, a content monitoring message displayed, a user input requested and/or other control actions initiated (blocks 870, 890).

According to some embodiments of the present invention, such discrepancies may be categorized by type. For example, discrepancies may be classified based on the type of action that may be desired in response to detection of the discrepancy. Table I illustrates some examples of types of discrepancies that may be detected:

TABLE I

| | | New Collective | Type of |
|---|---|---|---|
| Parameter | Current Content | Profile | Discrepancy |
| Max TV Rating | N/A | TV-Y | None |
| Max Movie Rating | PG-13 | G | 1 |
| Violence Level | Moderate | None | 1 |
| Sexual Content | Low | None | 1 |
| Time | 9 PM | 8 PM–3 AM | 1 |
| Volume | 9 | 8 | 2 |

In the instant examples, Type “1” discrepancies may be considered discrepancies for which content presentation may be terminated or suspended to allow for supervisory actions, as they indicate potential presentation of content that may be undesirable for the newly-detected audience member. Type “2” discrepancies Table 1, however, may be discrepancies for which control actions may be performed without requiring such intervention. For example, a Type “2” discrepancy, such as a volume discrepancy, may be addressed by automatically lowering the volume to the volume level in the new collective profile. A Type “1” discrepancy, such as a ratings mismatch, may initiate other actions, such as pausing the content presentation, chancing to “safe” content (e.g., a programming guide or menu), turning off a display of the content presentation device, muting the content presentation device, modifying advertising delivered in a content presentation (e.g., blocking adds for particular products and/or conforming to a pre-approved list) and/or requesting a modified or “safe” version of the current content from a content provider, along lines described in U.S. patent application Ser. No. 10/940,323 (Published as U.S. Patent Application Publication No. 2006/0059227), filed Sep. 14, 2004 and incorporated by reference herein in its entirety.

As discussed above with reference to FIG. 8, potential actions in response to detection of a discrepancy between current content and a collective profile may include generating a content monitoring message and suspending content presentation to allow for supervisory input from an authorized user in response to the message. For example, FIG. 9 illustrates display of a “program paused” message 910 on a display 112 of a content presentation device 110′. Such a message may be generated, for example, in response to detection of a discrepancy between the new collective profile generated when “Susie” is detected and parameters associated with Superman Returns™. As shown, the message 910 may include text indicating the reason(s) for suspension of the content presentation, as well as user input fields 912 that may be used to resume the content presentation or to transfer to a menu or other display that allows for further choices, such as selection of alternate content.

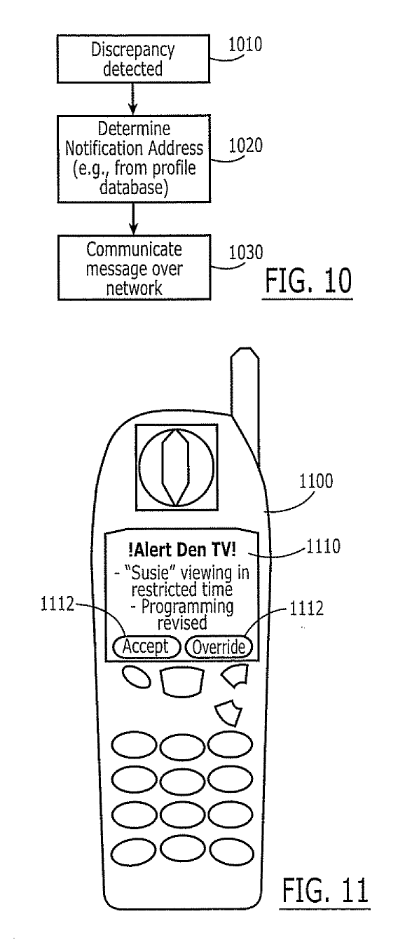

According to further embodiments of the present invention, content presentation monitoring may also employ remote devices, such as cellphones, PDAs, desktop and portable computers and other devices capable of communications with a content presentation controller, such as the audience-adaptive controller shown in FIG. 1. For example, as shown in FIG. 10, in response to detection of a discrepancy between a current content presentation and a collective profile (block 1010), a notification network address may be determined (block 1020), for example, by lookup in a profile database such as the profile database 125 of FIG. 1. A content presentation monitoring message may then be communicated to the determined network address (block 1030). For example, as shown in FIG. 11, such a message may be communicated over a cellular network to a cellular telephone 1100, which may responsively generate a display 1110 of the message, as well as icons for accepting user input of commands 1112 relating to the displayed message. It will be appreciated that a variety of other remote messaging techniques may be used in other embodiments of the present invention.

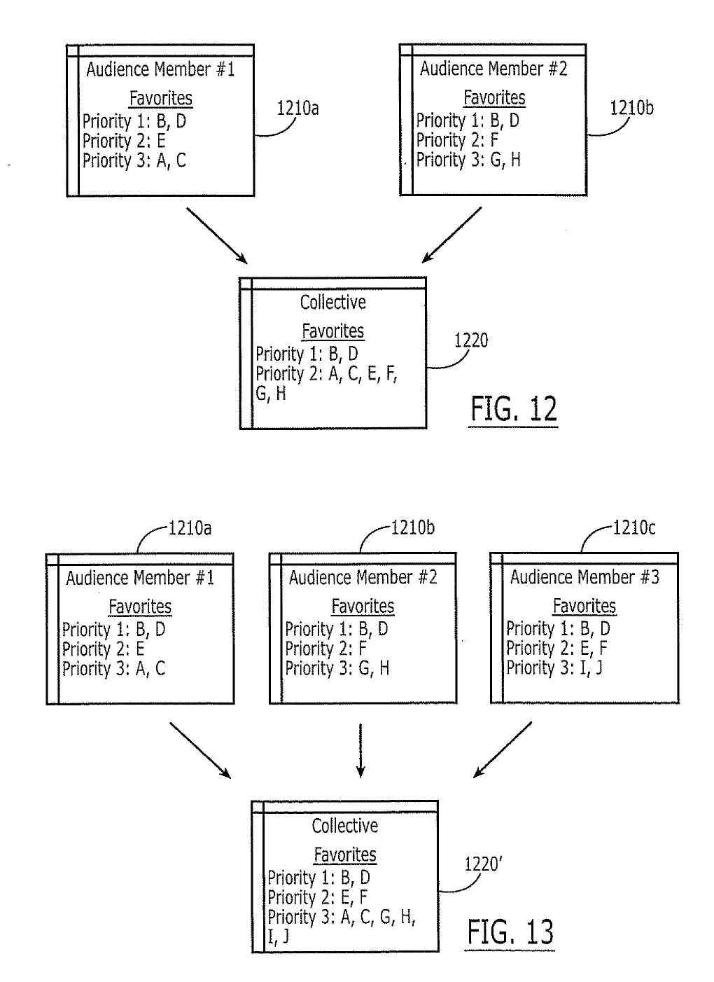

As noted above, adaptive content presentation control according to some embodiments of the present invention may include control of a content guide, such as a programming/channel guide. Such control actions may include, but are not limited to, deletion of items, addition of items and rearrangement of items. in the content guide. For example, referring to FIG. 12, responsive to detection of audience members #1 and #2, which have corresponding individual profiles 1210a, 1210b, respectively, that include different collections and prioritization of “Favorites,” a collective profile 1220 may be generated that includes “Favorites” that reflect the respective prioritizations of the individual profiles 1210a, 1210b. For example, in generating the collective profile 1220, the common “Priority 1” favorites B and D are identified and classified as “Priority 1” in the collective profile 1220. In the instant example, because of lack of commonality between the “Priority 2” and “Priority 3” favorites in the individual profiles 1210a, 1210b, they are not differentiated in the collective profile 1220, i.e., they are all classified as “Priority 2.” Referring to FIG. 13, however, when an audience member #3 having an individual profile 1210c is detected, a new collective profile 1220′ is generated, with “Favorites” prioritized based on a voting criterion. In particular, common “Priority 1” favorites B and D are grouped as “Priority 1” in the collective profile 1220′, while “Priority 2” favorites E and F of the collective profile 1220′ are identified based on their status as “Priority 2” for at least two of the three audience members. Other favorites A, C, G, H, I and J are classified as “Priority 3.” It will be understood that, in further embodiments of the present invention, a content guide may be controlled in ways other than the prioritization techniques described above.

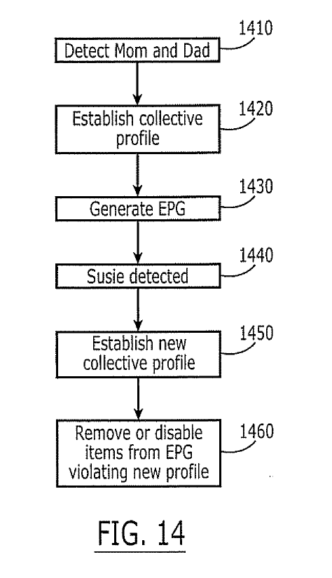

FIG. 14 illustrates exemplary operations for controlling a content guide according to further embodiments of the present invention. Upon detection of audience members “Mom” and “Dad” (block 1410), a collective profile may be established (block 1420). Based on the collective profile, an electronic programming guide (EPG) may be generated (block 1430), for example, based on ratings, favorites and/or other parameters in the collective profile. Upon subsequent detection of audience member “Susie” (block 1440), a new collective profile is generated (block 1450). Based on the new collective profile, items in the existing EPG violating requirements of the new collective profile, for example, new restrictions arising from Susie's individual profile parameters, may be disabled and/or removed (block 1460). It will be further understood that the EPG may also be modified in other ways. For example, arrangement of items in the EPG may be modified based on consideration of favorites and other parameters as modified in the new collective profile.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of presenting content, the method comprising:
storing a profile for each of a plurality of potential audience members;
detecting presence of a group of audience members of the plurality of potential audience members; and
controlling a content presentation device based on collective consideration of the stored profiles of the group of audience members.

2. The method of claim 1:
wherein detecting presence of a group of audience members of the plurality of potential audience members comprises detecting addition of a new audience member to a group of existing audience members; and
wherein controlling a content presentation device based on collective consideration of the stored profiles of the group of audience members comprises altering content presentation by the content presentation device responsive to the detection of the new audience member.

3. The method of claim 2, wherein altering content presentation by the content presentation device responsive to the detection of the new audience member comprises controlling the content presentation device based on a collective consideration of stored profiles of the new audience member and the group of existing audience members.

4. The method of claim 1, wherein the stored profiles each comprise a plurality of parameters, and wherein controlling a content presentation device based on collective consideration of the stored profiles of the group of audience members comprises applying different control arbitration rules for respective ones of the profile parameters.

5. The method of claim 1, wherein controlling a content presentation device based on collective consideration of the stored profiles of the group of audience members comprises:
generating a collective profile for the group of audience members from the stored profiles responsive to the detection of the group of audience members; and
controlling the content presentation device responsive to the collective profile.

6. The method of claim 1, wherein controlling a content presentation device based on collective consideration of the stored profiles of the group of audience members comprises suspending a presentation of content based on collective consideration of the stored profiles of the group of audience members, terminating a presentation of content based on collective consideration of the stored profiles of the group of audience members, controlling access to a content channel based on collective consideration of the stored profiles of the group of audience members, editing content based on collective consideration of the stored profiles of the group of audience members and/or providing supplemental content based on collective consideration of the stored profiles of the group of audience members.

7. The method of claim 1, wherein controlling a content presentation device based on collective consideration of the stored profiles of the group of audience members comprises generating a content monitoring message based on collective consideration of the stored profiles of the group of audience members.

8. The method of claim 7, wherein generating a content monitoring message based on collective consideration of the stored profiles of the group of audience members comprises generating an alarm and/or a message based on collective consideration of the stored profiles of the group of audience members.

9. The method of claim 1, wherein storing a profile for each of a plurality of potential audience members comprises storing a profile of a generic audience member.

10. The method of claim 1, wherein the stored profiles comprise an age grouping, a content rating, a presentation time parameter, a volume level and/or a content preference.

11. The method of claim 1:
wherein detecting presence of a group of audience members of the plurality of potential audience members comprises detecting loss of an audience member from a group of existing audience members; and
wherein controlling a content presentation device based on collective consideration of the stored profiles of the group of audience members comprises altering content presentation by the content presentation device responsive to the detection of the loss of the existing audience member.

12. The method of claim 1, wherein controlling a content presentation device based on collective consideration of the stored profiles of the group of audience members comprises providing a content guide based on collective consideration of the stored profiles of the group of audience members.

13. The method of claim 12, wherein providing a content guide based on collective consideration of the stored profiles of the group of audience members comprising arranging information in the content guide based on relative preferences of the group of audience members indicated in the stored profiles.

14. A computer program product comprising computer program code embodied in a storage medium, the computer program code comprising program code configured to implement the method of claim 1.

15. An apparatus configured to implement the method of claim 1.

16. A content presentation system comprising:
a content presentation device configured to provide an audio and/or visual output; and
an audience-adaptive controller configured to store a profile for each of a plurality of potential audience members, to detect presence of a group of audience members of the plurality of potential audience members and to control the content presentation device based on collective consideration of the stored profiles of the group of audience members.

17. The system of claim 16, wherein the audience-adaptive controller is configured to detect addition of a new audience member to a group of existing audience members and to alter a content presentation by the content presentation device responsive to the detection of the new audience member.

18. The system of claim 17, wherein the stored profiles each comprise a plurality of parameters, and wherein the audience-adaptive controller is configured to apply different control arbitration rules for respective ones of the profile parameters.

19. The system of claim 17, wherein the audience-adaptive controller is configured to generate a content monitoring message based on collective consideration of the stored profiles of the group of audience members.

20. The system of claim 17, wherein the audience-adaptive controller is configured to store a profile of a generic audience member.

21. The system of claim 17, wherein the audience-adaptive controller is configured to provide a content guide based on collective consideration of the stored profiles of the group of audience members.

22. The system of claim 13, wherein the audience-adaptive controller is configured to arrange information in the content guide based on relative preferences of the group of audience members indicated in the stored profiles.

23. A computer program product for controlling a content presentation device, the computer program product comprising computer program code embodied in a storage medium, the computer program code comprising:
program code configured to store a profile for each of a plurality of potential audience members, to detect presence of a group of audience members of the plurality of potential audience member and to control the content presentation device based on collective consideration of the stored profiles of the group of audience members.

24. A computer program product according to claim 23, wherein the program code configured to store a profile for each of a plurality of potential audience members, to detect presence of a group of audience members of the plurality of potential audience member and to control the content presentation device based on collective consideration of the stored profiles of the group of audience members comprises program code configured to detect addition of a new audience member to a group of existing audience members and to alter content presentation by the content presentation device responsive to the detection of the new audience member.

25. The computer program product of claim 23, wherein the program code configured to store a profile for each of a plurality of potential audience members, to detect presence of a group of audience members of the plurality of potential audience member and to control the content presentation device based on collective consideration of the stored profiles of the group of audience members comprises program code configured to generate a content monitoring message based on collective consideration of the stored profiles of the group of audience members.

26. The computer program product of claim 23, wherein the program code configured to store a profile for each of a plurality of potential audience members, to detect presence of a group of audience members of the plurality of potential audience member and to control the content presentation device based on collective consideration of the stored profiles of the group of audience members comprises program code configured to provide a content guide based on collective consideration of the stored profiles of the group of audience members.

27. The computer program product of claim 26, wherein the program code configured to provide a content guide based on collective consideration of the stored profiles of the group of audience members comprises program code configure to arrange information in the content guide based on relative preferences of the group of audience members indicated in the stored profiles.
